(19) United States
(12) Patent Application Publication
(10) Pub. No.: US 2016/0100564 A1
(43) Pub. Date: Apr. 14, 2016

(54) SELF-SUSTAINED RODLESS FISHING APPARATUS AND ALERT SYSTEM

(71) Applicants: REINALDO PEREZ, MIAMI, FL (US); SARA HERMINIA IZQUIERDO SOLARES, MIAMI, FL (US)

(72) Inventors: REINALDO PEREZ, MIAMI, FL (US); SARA HERMINIA IZQUIERDO SOLARES, MIAMI, FL (US)

(21) Appl. No.: 14/513,255

(22) Filed: Oct. 14, 2014

(51) Int. Cl. A01K 97/12; A01K 97/10; A01K 99/00

(52) U.S. Cl. CPC A01K 97/125; A01K 97/12; A01K 99/00; A01K 97/10

(57) ABSTRACT

The present invention provides a novel a fishing apparatus comprising a spool-retention-assembly, the spool-retention-assembly further comprising a sound-resistance disk defining a plurality of sound apertures, an axial-locking-mechanism, a reel-locking-mechanism, the reel-locking-mechanism further comprising a plurality of reel springs and a base-body defining at least one interior chamber for solid or liquid storage. Sound is created by allowing a vibrating pinhead to be protruded from the base body into intermittent contact with an axially rotatory sound-resistance disk.

### FIELD OF THE INVENTION

The present invention provides a novel fishing reel for use with or without a rod. More specifically, the present invention provides a way to warn a user when fish have taken the bate and is ready to be railed in.

### BACKGROUND OF THE INVENTION

Fishing from a pier or fishing bridge is a popular pastime for may anglers around the world, especially at night or nigh fishing. Some of bridges and piers jut only a few feet into the water, while others extend over large passes with fast moving water during the changing of the tides. These piers and bridges offer anglers a chance to fish waters that cannot be reached from shore or wading. Many types of fish hang around fishing piers because piers and bridges provide structure and food. At night, these fish can be seen cruising around the edges of the pier's shadows. Anglers at many piers catch most of the popular sport fish, as well as some other species like pinfish, shark, catfish, ladyfish, and spadefish.

Night, dusk, or dawn fishing is preferred because fishing its much more peaceful, and some experienced anglers believes that they catch larger fish at night. Anglers usually cast several reels at the same time and wait peacefully until the fish take the beat. During warm days, fish wait until things cool off in the evening to feed, so it's easier to catch them at night. Nights with a full moon, or brighter nights, are considered less prime fishing times, since fish have a tendency to be more aware of predator and are afraid to eat.

Most recreational fishers use a fishing rod with a fishing line and a hook at the end of the line. The rod may be equipped with a reel so the line can be reeled in, and some form of bait or a lure attached to the hook. Most modern reels were developed for fly fishing, or cast fishing in which the reel is attached to the back end of the rod, and heavy line is cast with a complex, repetitive whipping motion to deliver the ultra light artificial fly to its target. The problem is that this type of reel is not suitable for bridge, pier fishing, or stationary fishing at night since once the lines are cast, the river or ocean move as tides come and go inland bringing fish with it. Therefore, the repetitive whipping motion or any type of casting is not needed. The reel needed for this type of fishing includes a wide drum that spools out freely, and is ideal for allowing the bait to drift along way out with the current.

One of the disadvantages of modern reels is that they are not designed for fishing from piers at night where visibility is low and when several reels are cast at the same time. For example, most angles that use fishing rods, cannot leave them unattended because if a fish is caught, the rod will go to the water. There is a need in the industry to develop reels that are rod-less self-contained and that tells the angler when a fish is taking bate in multiple ways.

Therefore, a need exists to overcome the problems with the prior art as discussed above.

### SUMMARY OF THE INVENTION

The invention provides a self-sustained fishing apparatus and alert system that overcomes the hereinafore-mentioned disadvantages of the heretofore-known devices and methods of this general type.

With the foregoing and other objects in view, there is provided, in accordance with the invention, a fishing apparatus comprising a spool-retention-assembly, the spool-retention-assembly further comprising a sound-resistance disk defining a plurality of sound apertures, an axial-locking-mechanism, a reel-locking-mechanism, the reel-locking-mechanism further comprising a plurality of reel springs; and a base-body defining at least one interior chamber for solid or liquid storage.

In accordance with another feature, an embodiment of the present invention includes a vibrating pin assembly further comprises a vibrating pin intermittently coupling with the sound resistance disk to create at least a sound to alert a user.

In accordance with a further feature of the present invention, the clutch assembly further comprises a brake pad intermittently coupling with the sound resistance disk to create friction against the sound resistance disk.

In accordance with the present invention, a method for to alert a user of a catch, the method comprising providing fishing apparatus comprising a base-body defining a selectively openable intake opening to permit solids or liquids intake; at least one interior chamber; and a plurality of thru-apertures to be demountably coupled with a clutch assembly and a vibrating pin assembly and allowing a vibrating pin head to be protruded from the base body into intermittent contact with an axially rotatory sound-resistance disk to create at least one sound.

In accordance with another feature, an embodiment of the present invention also includes the sound-resistance disk is centered and mounted around a rotating-axis.

In accordance with yet another feature, an embodiment of the present invention includes a light assembly, a line guide, and a rod retention assembly.

In accordance with a further feature of the present invention, includes a clutch assembly further comprises a brake pad intermittently coupling with the sound resistance disk to create friction against the sound resistance disk.

Although the invention is illustrated and described as embodied in a self-sustained fishing apparatus and alert system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

As used in the specification and in the claims the term “demountably coupled” shall refer to be able to be removed on and off without much effort many times; as a non-limiting example, it may include de use of multiple types of mechanical couplings, magnetic coupling, locks, glues, and many more.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a downward orthogonal exploited view of top part of the fishing apparatus depicting a spool shaft nut assembly, reel locking spring assembly, and the vibrating pin assembly;

FIG. 2 is a is an upward orthogonal exploited view of FIG. 1, the top part of the fishing apparatus, showing the spool shaft nut assembly, the reel locking spring assembly, the sound and resistance disk, and the vibrating pin assembly;

FIG. 3 is a downward orthogonal of the base assembly showing the spool shaft and the water intake opening;

FIG. 4 is a is a bottom view of FIG. 3 of the base assembly showing a plurality of openings where the vibrating pin assembly is inserted;

FIG. 5 downward orthogonal view of FIGS. 1-3, depicting the reel as it is inserted into the base assembly through the center axis;

FIG. 6 downward orthogonal view of FIGS. 1-3, depicting the reel as it is locked into place into the base assembly;

FIG. 7 cross-sectional vies of FIG. 6 showing water chamber inside the base assembly and the inside of the vibrating pin assembly as lays inside the water chamber;

FIG. 8 is a close detailed cross-sectional view of FIG. 7;

FIG. 9 is a close detailed cross-sectional view of the tip of the vibrating pin as it touches the sound disk;

FIG. 10 is a cross-sectional side view of the vibrating pin.

FIG. 11 is orthogonal downward view of an alternative embodiment where the water intake opening is at the center of the axis of rotation.

FIG. 12 is an orthogonal downward view of the alternative embodiment of FIG. 11, where the water intake opening is at the center of the axis of rotation and showing the rod retention assembly.

FIG. 13 is an exploited downward view of the alternative embodiment of FIGS. 11-12, where the water intake opening is at the center of the axis of rotation and showing the detail of the rod retention assembly.

FIG. 14 is a side view of the alternative embodiment of FIGS. 11-13, showing the details of the rod retention assembly's angles of movement and freedom.

FIG. 15 is an orthogonal downward view of an alternative embodiment of the fishing apparatus depicting the light assembly and the line guide.

### DETAILED DESCRIPTION

While the specification concludes with claims defining the features of the invention regarded as novel, it is believed that the invention will be better understood with the following description with the drawing figures, in which like reference numerals are carried forward. The disclosed embodiments are merely exemplary of the invention, which can be embodied in various forms.

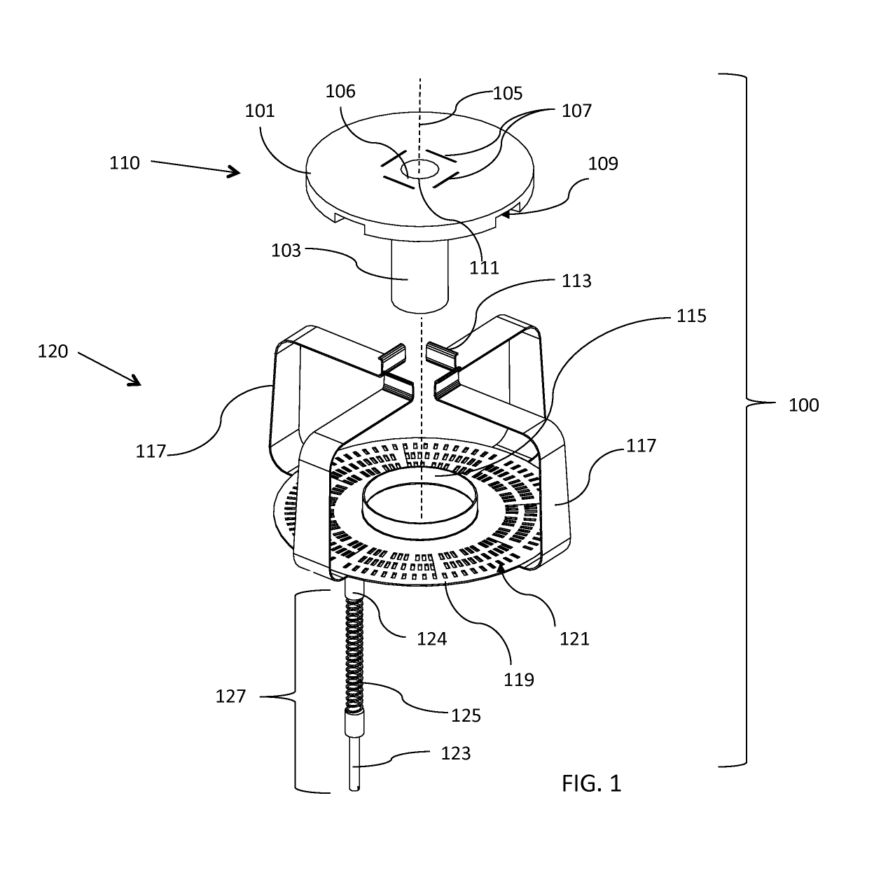

The present invention provides a novel and efficient a self-sustained fishing apparatus and alert system. Embodiments of the invention provide a self-sustained fishing apparatus and alert system to include a spool-retention-assembly and a base-assembly. Embodiments of the invention provide several base-assemblies, to provide for a base for the spool-retention-assembly to receive and lock commercially available fishing spools. Referring now to FIG. 1, one embodiment of the present invention is in a downward orthogonal view. FIG. 1 shows several advantageous features of the present invention, but, the invention can be provided in several shapes, sizes, combinations of features and components, and varying numbers and functions of the components.

The first example of the spool-retention-assembly 100 is shown in FIG. 1. The spool-retention-assembly 100 includes an axial-locking-mechanism 110 and a reel-locking-mechanism 120. On the lower portion of the reel-locking-mechanism 120, the sound-resistance disk 119 is shown with the clutch-assembly 127 underneath. In this embodiment of the spool-retention-assembly 100, the axial-locking-mechanism 110 and a reel-locking-mechanism 120 and the sound-resistance disk 119, are centered and mounted around rotating-axis 105.

The axial-locking-mechanism 110 further includes: the spool shaft nut 101, the reel-spring-apertures 107, the reel-spring-guides 109, the axial bolt retention aperture 106, and the spool shaft busing 103. The reel-locking-mechanism 120 includes a plurality of reel springs 117 that are demountably disposed on the bottom part of the sound-resistance disk 119 and to the axial-locking-mechanism 110 by locking the reel spring tips 113 into the reel-spring-apertures 107. The sound-resistance disk 119 is centered around the rotating axis 105 and it includes a plurality of sound apertures 121. The clutch assembly 127 includes a screw head 123 on the bottom part that is connected to a cylindrical brake pad 124 on the top part via a clutch spring 125.

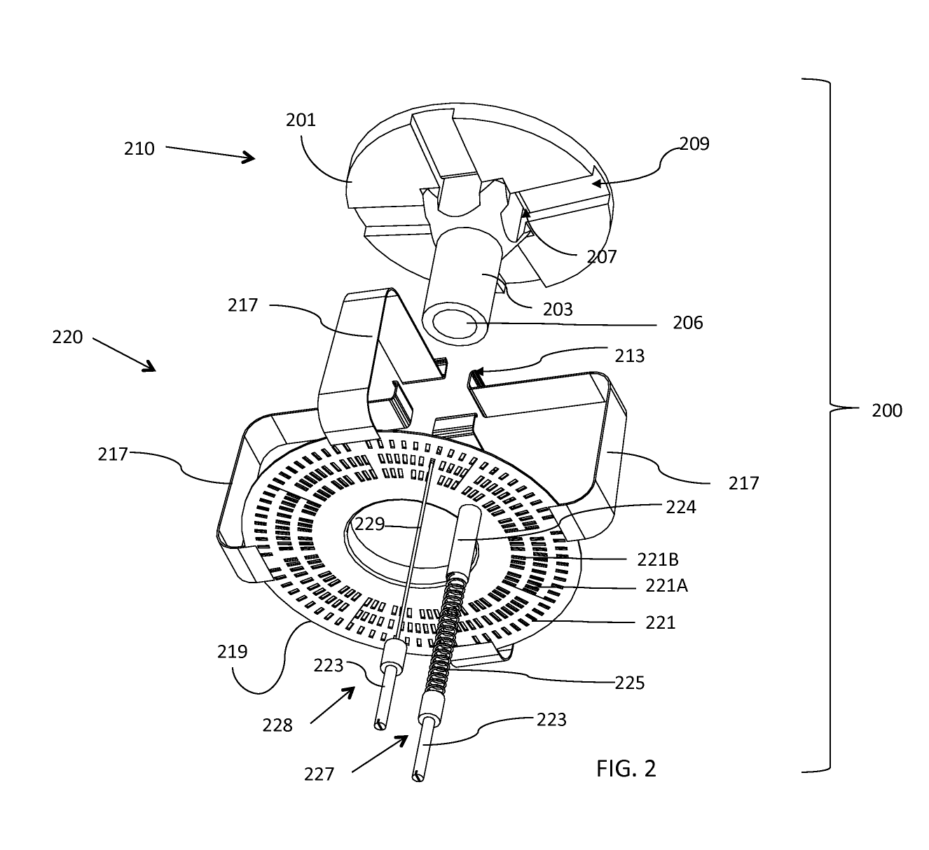

A more detailed view of the functionality of the spool retention assembly 200 is now depicted in FIG. 2. FIG. 2 is in an upward orthogonal view of the spool retention assembly 200. As previously seen in FIG. 1, the spool-retention-assembly 200 includes an axial-locking-mechanism 210, and a reel-locking-mechanism 220. This view shows how the reel springs 217 would mate to the spool shaft nut 201 guided by the reel-spring-guides 209 and locked into place by the reel-spring-apertures 207. Here, the axial bolt retention aperture 206 can be shown as well as the spool shaft 203. The sound resistance disk 219 includes a plurality of sound apertures 221 that are concentrically disposed on the sound-resistance disk 219. In this embodiment there a three sets of concentrically disposed apertures, 221, 221A, and 221B. Each concentrically disposed set of apertures disposed on the sound-resistance disk 219 corresponds to a particular type of sound emitted by the interaction with the vibrating pin assembly 228. The vibrating pin assembly 228 includes an elongated vibrating pin 229 on the top end and a slender screw head 223 on the bottom end. The particular type of sound is created by the distance between the sound apertures 221 to each other and their frequency. It is envisioned that there are other types of ways to create sound on the sound-resistance disk 219 such with dimples or protrusions. The clutch assembly 227 uses a screw head 223 to tighten or loosen the cylindrical brake pad 224 on the top to create friction against the sound-resistance disk 219 and using the clutch spring 225 as a buffer.

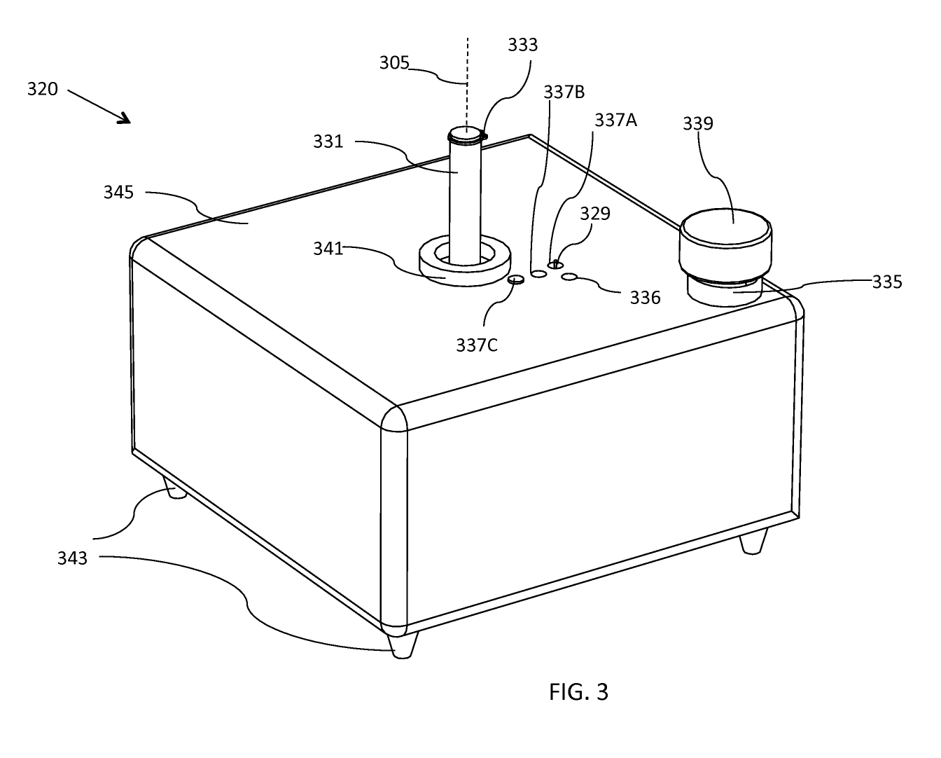

Referring now to FIG. 3, one embodiment of the present invention is in a downward orthogonal view of the base assembly 320. FIG. 3 shows several advantageous features of the base assembly 320, but, the base assembly 320 can be provided in several shapes, sizes, combinations of features and components, and varying numbers and functions of the components. Here, the base assembly 320 is made of a base-body 345 that can be filled with liquids such as water or solids such as sand by using the water intake opening 335 and sealing it with a lid 339. The bottom of the base-body 345 is laid with grip-protrusions 343 to grip to the concrete or ground. On the center of the base-body 345 and along the rotating axis 305 is the spool shaft 331 that couples with the spool-retention-assembly 200 previously shown in FIG. 1 and FIG. 2. The spool shaft 331 includes a wrist pin 333 to lock the mating spool-retention-assembly 200 (From FIG. 1) in place. The spool (not shown) is supposed to rotate along rotating-axis 105 on a circular bushing 341 that is part of the top of the base-body 345. The base-body 345 includes a plurality of thru-apertures such as 337A, 337B, and 337C from which the tip of the vibrating pin 329 protrudes and makes contact with the sound resistance disk (shown in FIG. 1 as 119). Aperture 336 allows the clutch assembly 127 (not shown) to protrude and create friction against the sound resistance disk (shown previously in FIG. 1 as number 119).

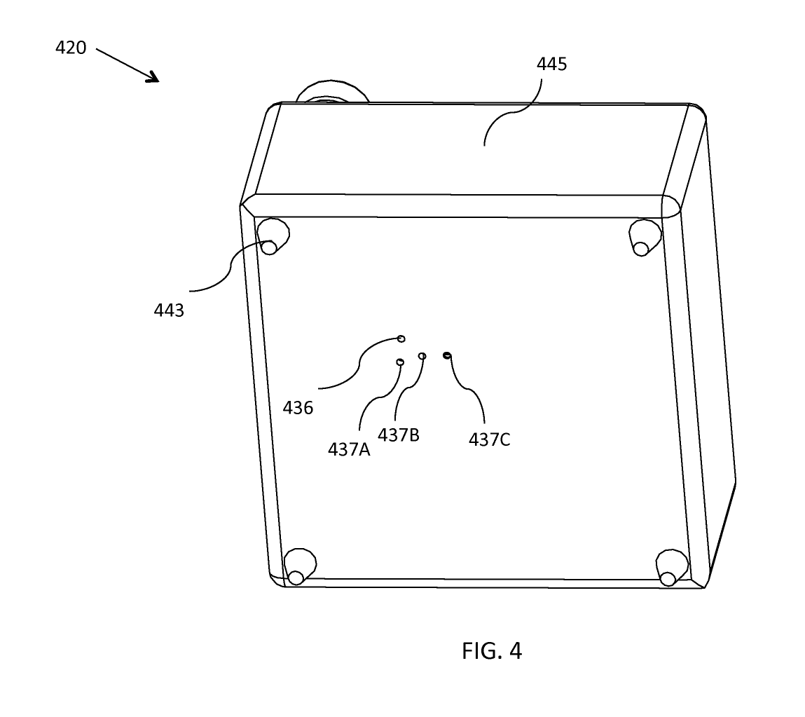

A more detailed view of the functionality of the base assembly 420 is now depicted in FIG. 4. FIG. 4 is in an upward orthogonal view of the base assembly 420. As previously seen in FIG. 3, the base-assembly 420 includes a plurality of thru-apertures such as 437A, 437B, 437C, and 436, that are cylindrical thru-holes from the bottom side of the base body 445 to top. In this embodiment the grip protrusions 443 are made out of rubber, but it is envisioned to be made also out of metal or other composite materials and could vary in length to be anchored to the ground.

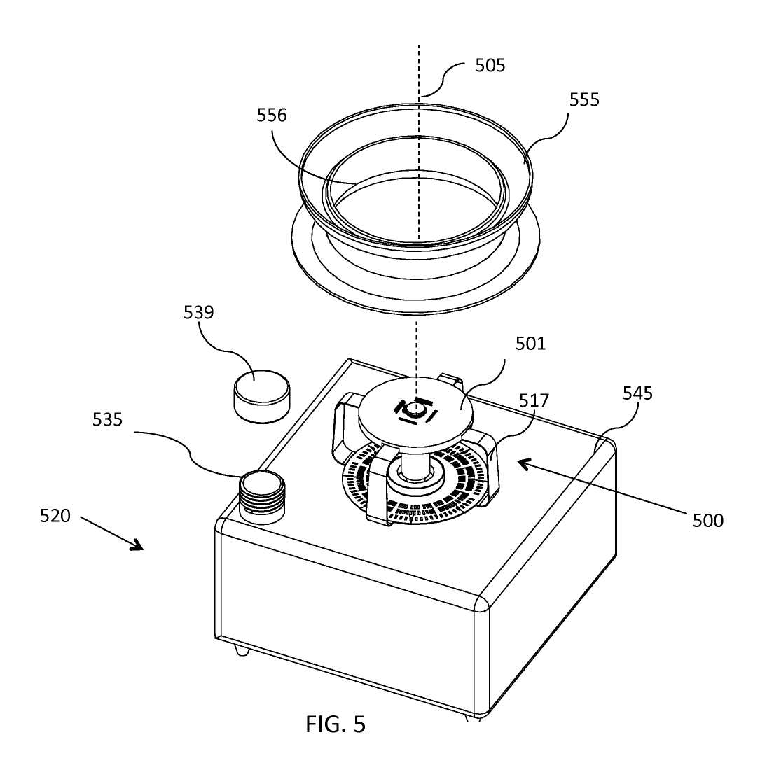

FIG. 5 is in a downward orthogonal view of the self-sustained fishing apparatus and alert system as the spool-retention-assembly 500 comes down into place through the rotating-axis 505. Here the spool-retention-assembly 500 is coupledly mated to the axial-locking-mechanism (previously shown as number 110), and the reel-locking-mechanism (previously shown as number 120), on to the base assembly 520 along rotating axis 505. The reel 555 is of a commercially standard size, and it demountably locks into place by being pushed against the reel springs 517 and then snuggly mating against the inside-reel-wall 556. The mating of the reel 555 to the spool-retention-assembly 500 is made so the user can easily remove it once fish has taken the bate. It is envisioned that other types of locking mechanisms could be used, not necessarily making it easy to remove the reel, one non-limiting illustrative example is by using a release pin or release pushbutton. Here, the water intake opening 535 and lid 539 can be seen on top of the base body 545, and is used to fill with a liquid such as water available where the angler is fishing. At least one reason to have the interior of the base-body 545 filled with water, sand, or cement, is to make the fishing apparatus stay when the fish takes the bate. Other materials that could be used for the same purposes include small stones and lead pellets. It is envisioned that the base-body 545 is made out of plastic non-corrosive materials such as injection molded plastics, but as an alternative stainless steel could also be used.

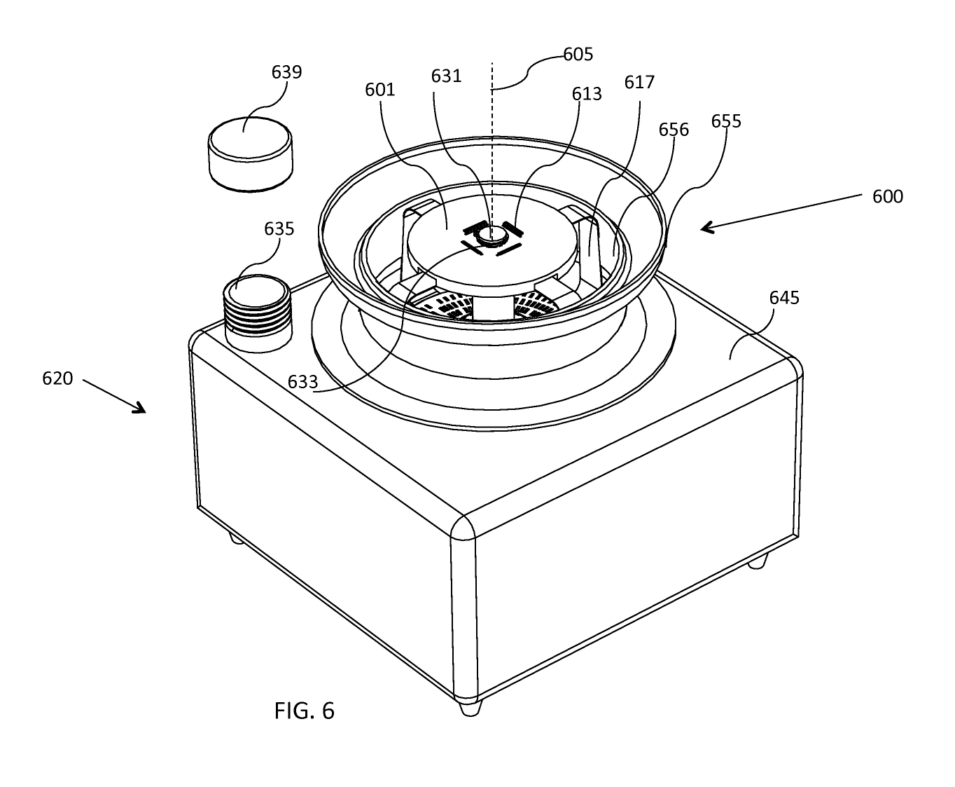

FIG. 6 is in a downward orthogonal view of the self-sustained fishing apparatus and alert system as the reel is coupledly placed into the reel springs 617, using the spool-shaft 631 as a guide, and then snuggly mating against the inside-reel-wall 656. Here, in one embodiment of the reel springs 617, are made from stainless steel because of its flexibility as a spring material, but it is envisioned that other metals could be used. The reel springs 617, in this embodiment four, are placed axially around rotating axis 605, and opposite each other. It is further envisioned that more or less units of reel springs 617 be used for the same purpose and to achieve the same snuggly mating result. In this embodiment, the spool shaft cap 601 is also used a rotating bussing that is rotates along the rotating axis 605. In this embodiment the spool-shaft-cap 601 is made out of TEFLON® because it creates the least friction against the metal spool-shaft 631. Other materials could be used as the spool-shaft-cap 601 include other soft polymers, composites, or metals, but using grease or bearings to reduce the friction between the spool-shaft-cap 601 and the metal spool-shaft 631.

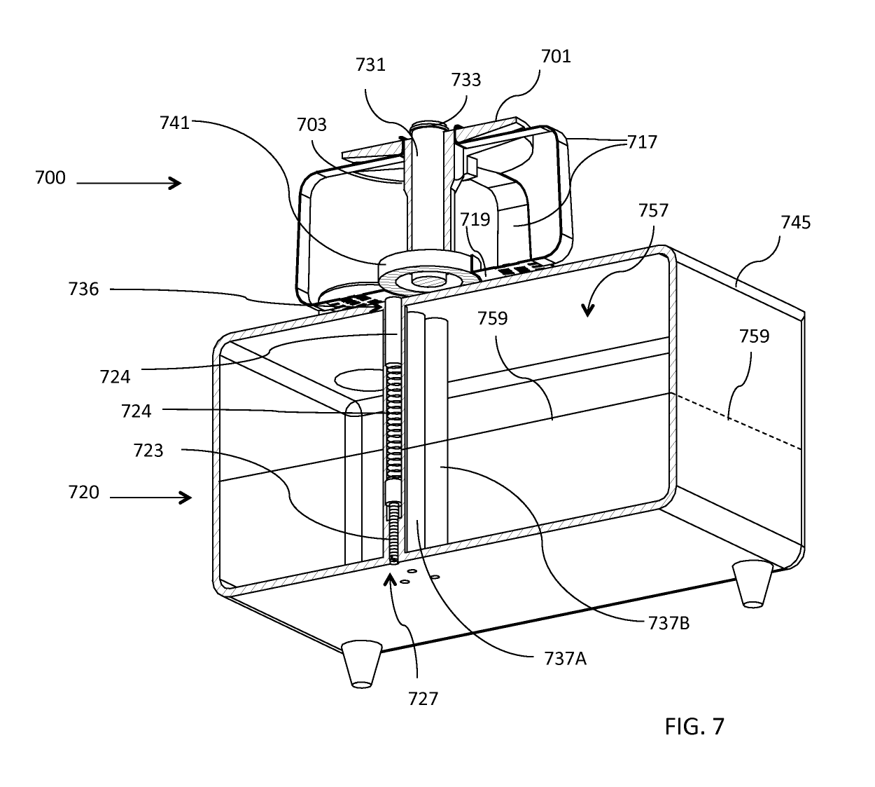

FIG. 7 is in an upward cross-sectional view of the self-sustained fishing apparatus and alert system showing a cross-section of the spool-retention-assembly 700 on the top of the base-assembly 720. In this embodiment, the interior chamber 757 of the base-body 745 is filled with water 759. The thru-apertures 737A and 737B can be seen how they isolate the clutch assembly 727 and the vibrating pin assembly (previously shown in FIG. 2. as 228) from the water 759. The top opening 736 allows for the cylindrical brake pad 724 to grind and create friction against the sound-resistance disk 736 and the friction coefficient can be adjusted using the slender screw head 723, located at the bottom of the base-body 745, transmitting the force through clutch spring 724. It is envisioned the cylindrical brake pad 724 to be made out of composite materials such as carbon composites, rubber or heavy metals such as tungsten, but also lighter metals could be used for economy. The circular bushing 741 also serves as a guide for the sound-resistance disk 719 to go around. In this embodiment, the circular bushing 741 is made out of TEFLON® or other similar frictionless composite material or metals. In this cross-sectional view of FIG. 7, the spool-retention-assembly 700 (that includes the includes an axial-locking-mechanism, and a reel-locking-mechanism) is detailed to show how it locks into place. The spool-shaft-cap 701 slides into place inside of the spool shaft 331 and is designed to rotate inside the spool shaft bushing 703 while being locked into place by wrist pin 733.

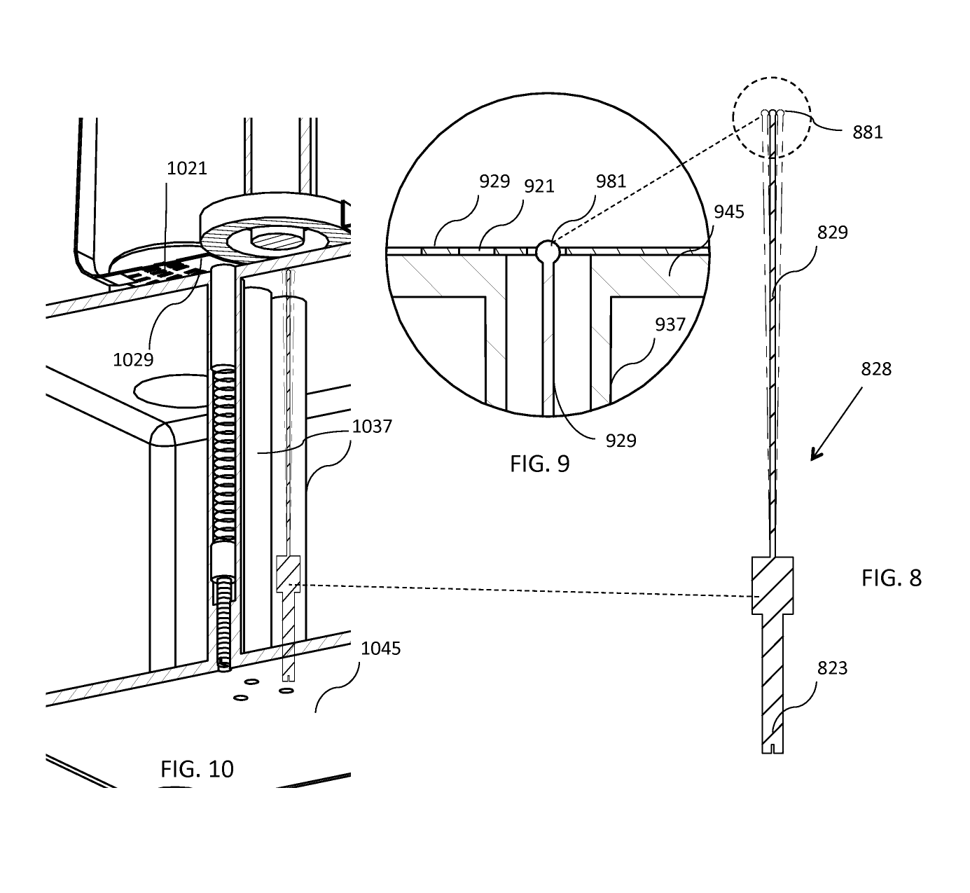

FIG. 8 is in a cross-sectional view of the vibrating pin assembly 828, which includes the vibrating pin 829, the slender screw head 823 at the bottom end and the pinhead 881 on the opposite top end. FIG. 9 is a detailed cross-sectional view of the top part of the vibrating pin assembly shown in FIG. 8, as it interacts with the sound resistant disk 921 to create sound inside the thru aperture 937 on the top part of the base-body 945. As the sound resistance disk 929 rotates, (rotation is caused by the fish pulling on the line that is rolled into the reel) the pinhead 981 will fall inside the plurality of sound apertures 921. As the pinhead 981 goes in and out of the sound apertures 921, the vibrating pin 929 vibrates in a rapid fashion creating a sound and alerting the user that a fish has taken the bate. At least one of the advantages of the mechanical nature of the making of the sound by vibrating the vibrating pin 929 is that it does not require any electrical circuitry. Although it is envisioned that a hybrid mechanism could be used by adding electrical components to create sound including a circuit board with at least one chip and a speaker. Nevertheless, one of the many advantages of having a purely mechanical device is its simplicity and the fact that no batteries are needed. Many angles and users are usually in isolated places far away from civilization and the less the equipment is required to catch a fish the better.

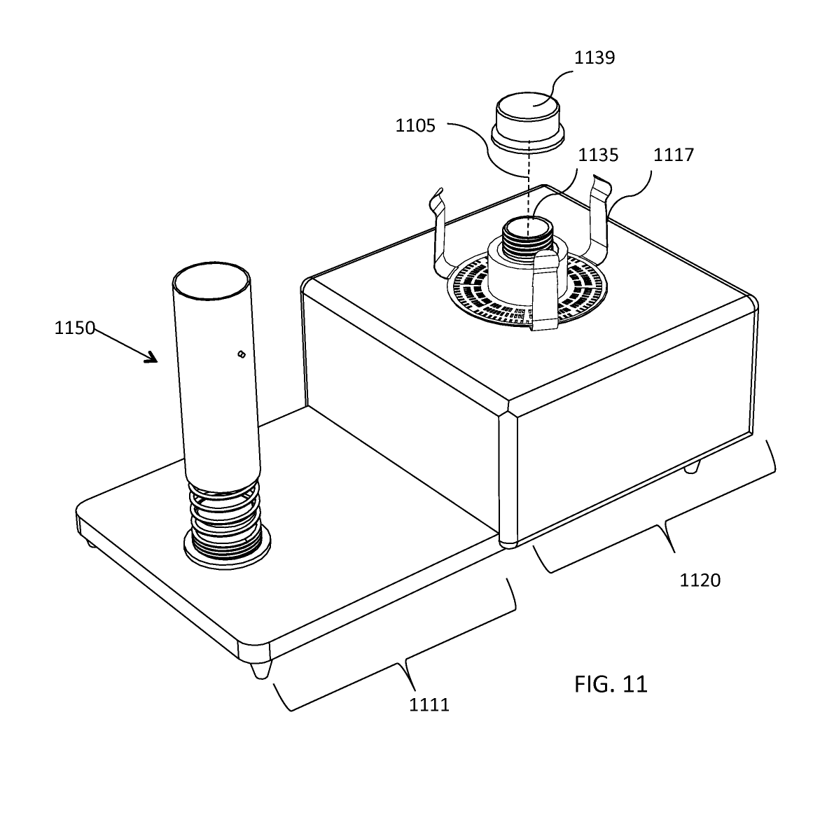

FIG. 10 is a cross-sectional upward view base-body 1045 that shows the location within thru-aperture 1037 of the vibrating pin assembly previously shown in FIG. 8 and FIG. 9. It is envisioned that the base-body 1045 contain a plurality of thru-apertures 1037 so that the vibrating pin assembly (shown as 828 in FIG. 8) can be moved from one thru-aperture 1037 to another. At least one of the advantages of the sound-making device alert system, is that one thru-aperture 1037 correspond to a set of sound apertures 1021 in the sound-resistance disk 1029 and this allows to have multiple kinds of sounds as the vibrating pinhead hits the particular sound apertures 1021. This way if a user has multiple fishing apparatus, the user will know just by the sound of the sound aperture 1021 pattern, what fishing apparatus to attend. This is a useful feature for anglers since most of the fishing is typically done at dawn, dusk, or even in complete darkness, hence it allows for quick identification of the fishing apparatus with a catch.

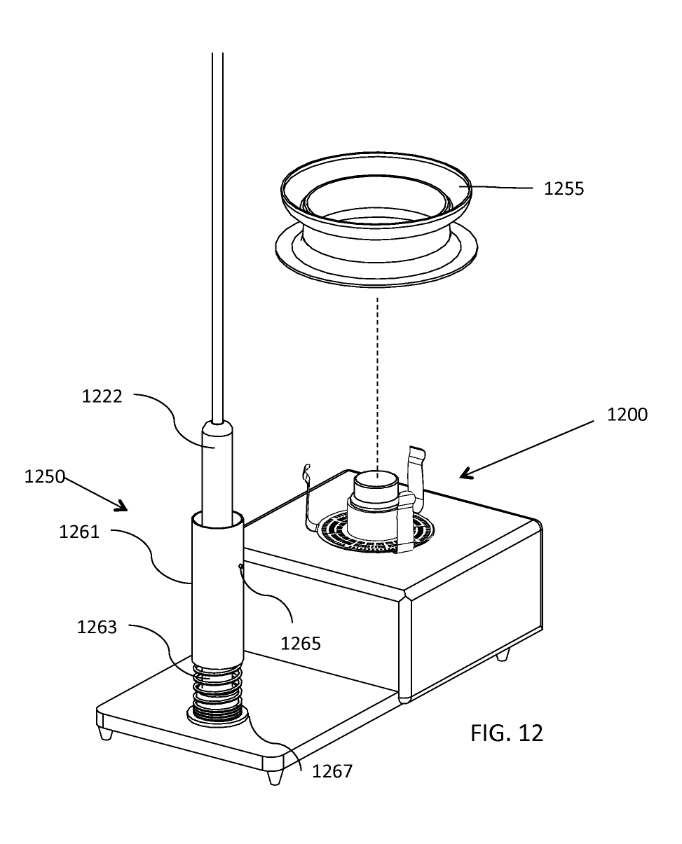

FIG. 11 is in a downward orthogonal view of an alternative embodiment of the self-sustained fishing apparatus and alert system. Here an extended platform 1111 is attached to the edge of the base assembly 1120. At least one of the purposes of the extended platform 1111 is to allow for a rod-retention assembly 1150. Sometimes, anglers prefer to have a rod with them to cast the lure or bate farther out to sea. This embodiment allows for having both a rod and an alert system so they are able to identify and be alerted when the rod or the fishing apparatus has a catch. In this embodiment, the water intake opening 1135 and corresponding lid 1139 are placed along the rotating axis 1105. Notice that the reel-retention assembly only requires three reel springs 1117 to retain a commercially sized reel (not shown).

FIG. 12 is in a downward orthogonal view of the alternative embodiment of the self-sustained fishing apparatus and alert system previously shown in FIG. 11. Here, the accessories of the reel 1255 and the rod 1222 can be seen as they couple with the reel-retention assembly 1200 and the rod-retention assembly 1250. The rod retention assembly includes a rod female receptor 1261, a locking screw 1265, a rod spring 1263, and a spring base 1267. The locking screw 1261 is there to lock the rod 1222 into place so that when a fish has taken the bate it does not take the rod with it.

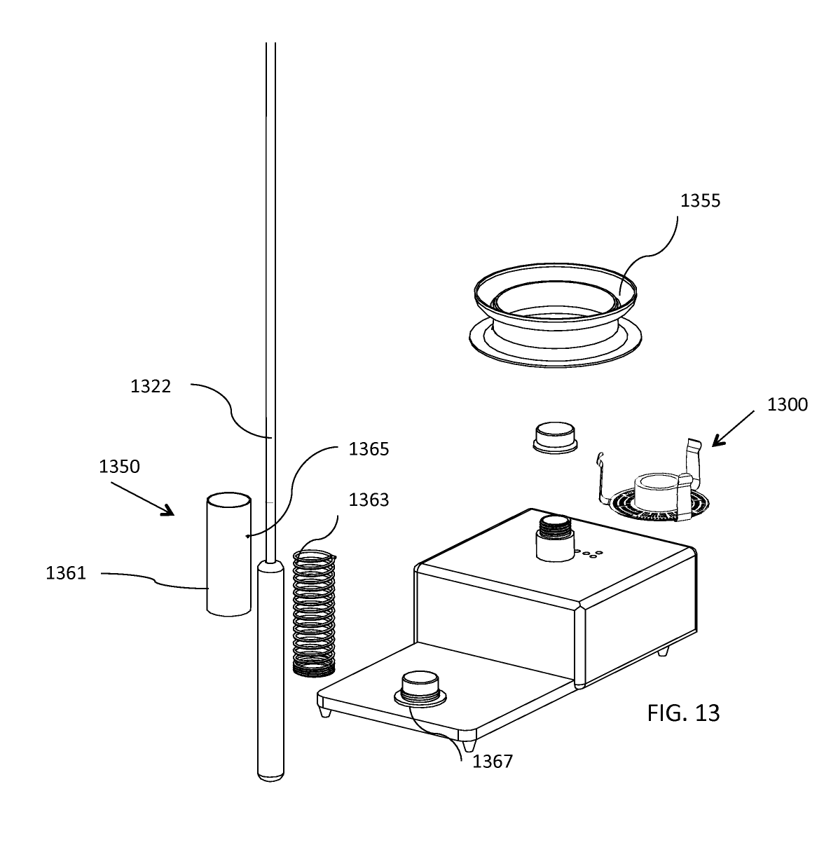

FIG. 13 is in a downward exploited view of the alternative embodiment of the self-sustained fishing apparatus and alert system previously shown in FIG. 12 and FIG. 11. Here, the accessories of the reel 1355 and the rod 1322 are of standard size and dimensions available at any commercial outlet so that any reel can fit into the reel-retention assembly 1300. The exploited rod retention assembly parts include: the rod female receptor 1361, the locking screw 1365, the rod spring 1363, and the spring base 1367.

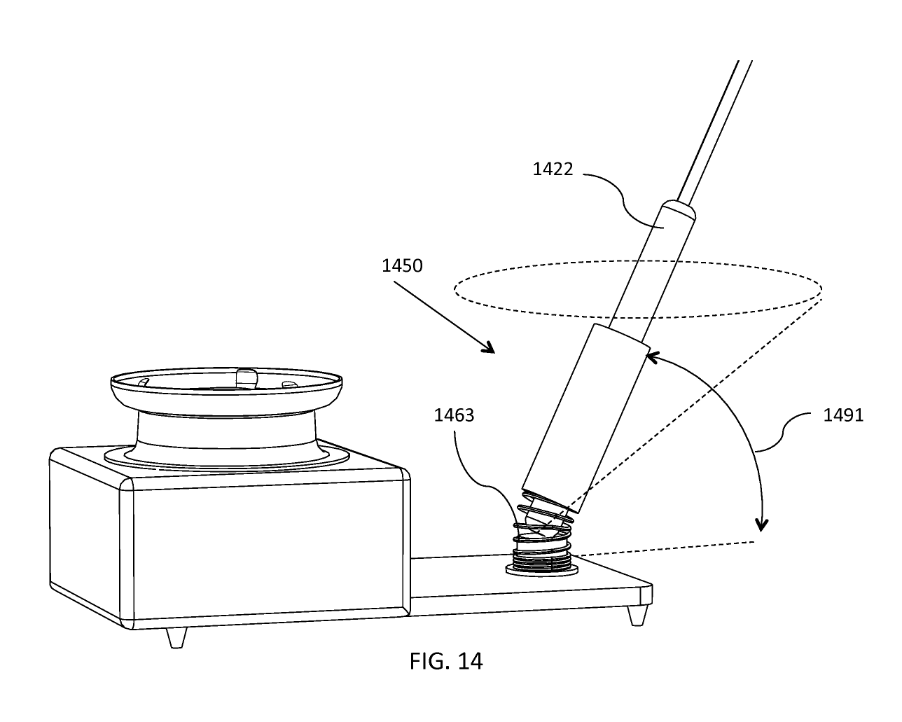

FIG. 14 is a side view of the alternative embodiment of the self-sustained fishing apparatus and alert system previously shown in FIGS. 11-13. Here, the rod retention assembly 1450 is shown to be able to move the rod 1422 in from 0 degree to a 90 degree angle 1491 by allowing the rod spring 1463 to bend in any direction. It also allows the rod 1422 to move in a 360 degree angle horizontally, giving the rod 1422 maximum freedom of movement. This freedom of movement is desired since sometimes anglers are in places with many other anglers and this avoids line entanglement.

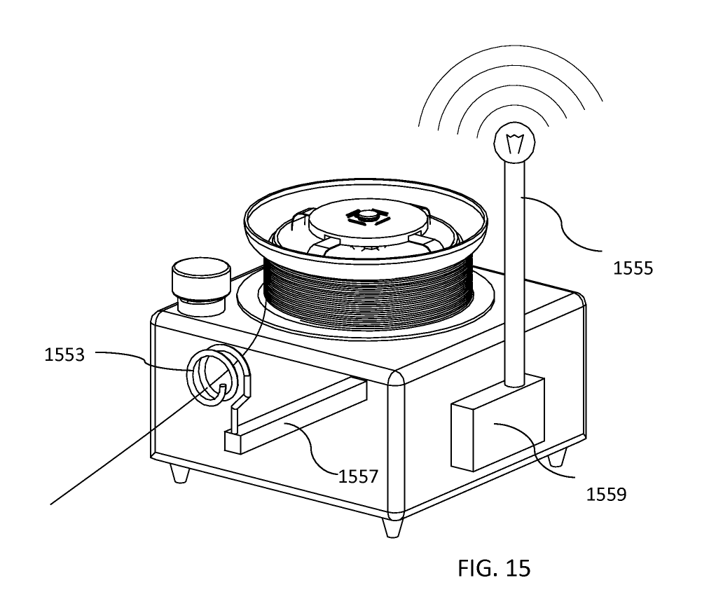

FIG. 15 is in a downward orthogonal of another alternative embodiment of the self-sustained fishing apparatus and alert system. Here, the alternative embodiment features a light assembly 1555 that incorporates an LED or incandescent light. The LED light is turned on when a fish catches the lure and makes the fishing apparatus vibrate. A motion sensor 1559 is incorporated into the light assembly 1555 to turn on the light. Another envisioned way to have the light turn on is by using the rotating movements of the reel wind a small generator that in turns lights the bulb or LED. In this alternative embodiment of FIG. 15, a line guide 1557 is also shown. The line guide 1557 allows the line to follow a specific path and not to tangle with others when fish has taken the bate. Another feature of the line guide 1557 is the easy to insert and release guide loop 1553. Angles have very little time to unhook the reel and fight the fish into submission, having an easy to release guide loop 1553, as shown here, allows for this to occur seamlessly.

A portable fishing apparatus and alert system has been disclosed in several embodiments. Within the fishing apparatus the alert system inside have also been disclosed. The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are within the meaning and range of equivalents of the disclosed embodiments, based on the teaching and guidance presented herein. The phraseology or terminology is for description and not of limitation, such that the terminology or phraseology of the present specification is interpreted by the skilled artisan in light of the teachings and guidance. The breadth and scope of the present invention should not be limited by the above-described exemplary embodiments, but should be defined only under the following claims and their equivalents.

What we claim is:

1. A fishing apparatus comprising:
a spool-retention-assembly, the spool-retention-assembly further comprising a sound-resistance disk defining a plurality of sound apertures, an axial-locking-mechanism, a reel-locking-mechanism, the reel-locking-mechanism further comprising a plurality of reel springs;
and
a base-body defining at least one interior chamber for solid or liquid storage.

2. The fishing apparatus of claim 1, further comprising,
a vibrating pin assembly and a clutch assembly.

3. The fishing apparatus of claim 2, wherein,
the vibrating pin assembly further comprises a vibrating pin intermittently coupling with the sound resistance disk to create at least a sound to alert a user.

4. The fishing apparatus of claim 2, wherein,
the clutch assembly further comprises a brake pad intermittently coupling with the sound resistance disk to create friction against the sound resistance disk.

5. The fishing apparatus of claim 1, wherein,
the sound-resistance disk is centered and mounted around a rotating-axis.

6. The fishing apparatus of claim 1, wherein,
the sound-resistance disk defines a plurality of apertures to create a plurality of sounds when demountably intermittently coupled with the vibrating pin.

7. A fishing apparatus comprising:
a base-body defining:
a selectively openable intake opening to permit solids or liquids intake;
at least one interior chamber;
and
a plurality of thru-apertures to be demountably coupled with a clutch assembly and a vibrating pin assembly to be protruded from the base body into intermittent contact with an axially rotatory sound-resistance disk.

8. The fishing apparatus of claim 7, wherein,
the vibrating pin assembly is intermittently coupled with the sound resistance disk to create at least a sound to alert a user.

9. The fishing apparatus of claim 7, wherein,
the clutch assembly further comprises a brake pad intermittently coupling with the sound resistance disk to create friction against the sound resistance disk.

10. The fishing apparatus of claim 7, wherein,
the sound-resistance disk is centered and mounted around a rotating-axis.

11. The fishing apparatus of claim 7, further comprising:
a light assembly, a line guide, and a rod retention assembly.

12. A method to alert a user of a catch, the method comprising:
providing fishing apparatus comprising:
a base-body defining:
a selectively openable intake opening to permit solids or liquids intake;
at least one interior chamber;
and
a plurality of thru-apertures to be demountably coupled with a clutch assembly and a vibrating pin assembly.
and
allowing a vibrating pin head to be protruded from the base body into intermittent contact with an axially rotatory sound-resistance disk to create at least one sound.

13. The fishing apparatus of claim 12, wherein,
the clutch assembly further comprises a brake pad intermittently coupling with the axially rotatory sound resistance disk to create friction against the sound resistance disk.

14. The fishing apparatus of claim 12, wherein,
the axially rotatory sound-resistance disk is centered and mounted around a rotating-axis.

15. The fishing apparatus of claim 12, further comprising:
a light assembly, a line guide, and a rod retention assembly.
